(19) United States
(12) Patent Application Publication
(10) Pub. No.: US 2003/0151627 A1
(43) Pub. Date: Aug. 14, 2003

(54) System and method for controlling real-time display

(75) Inventors: Timothy Andreas Meserth, Durham, NC (US); Heather N. Sterling, Blacksburg, VA (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/075,861

(22) Filed: Feb. 14, 2002

(51) Int. Cl. G09G 5/00

(52) U.S. Cl. 345/772; 345/835; 345/440

(57) ABSTRACT

A system and method in which a real-time display includes a graphical user interface that enables the user to control the display screen. More specifically, the display screen may include a slider control icon that determines the amount of historical data that is retained after the display screen fills up and the location of the next data point following a screen update. The slider control icon enables greater flexibility in displaying real-time data through an easy to use interface. In one embodiment, the system determines whether the display screen is full when it detects a new data point. If the display screen is full, the system determines the location of the slider icon. Based upon the determined position of the slider icon, the system shifts the historical data, discards portions of the historical data, and begins appending new data points at the position of the slider. At one extreme position of the slider, all historical data is erased after the screen fills up while, at the other extreme, only a single historical data point is deleted when a new data point is generated.

### BACKGROUND

1. Field of the Present Invention

The present invention generally relates to the field of data processing systems and more particularly to a system and method for controlling a real-time display by enabling the user to modify the graph update rate.

2. History of Related Art

In the field of data processing systems, real-time displays are commonly encountered in a variety of applications. In desktop, laptop, and server applications, real-time displays are typically encountered in system utility software such as hardware performance monitors that are commonly included as a part of commercially distributed operating systems and hardware management software. These real-time display routines may be invoked to chart a wide variety of real-time information including information that changes relatively slowly and information that changes rapidly. Unfortunately, the design of these applications typically prevents the user from making any significant adjustments to the manner in which data is displayed. It would therefore be desirable to implement a system and method that enabled users to modify the manner in which real-time data is displayed on a data processing system. It would be further desirable if the implemented solution was easy to use and did not substantially affect the cost or complexity of the performance monitoring or other application employing the real time display.

### SUMMARY OF THE INVENTION

The problems identified above are in large part addressed by a system and method in which a real-time display includes a graphical user interface that enables the user to control display parameters. The display screen may include a slider control icon that determines the amount of historical data that is retained after the display screen fills up. In one embodiment, the system determines whether the display screen is full when it detects a new data point. If the display screen is full, the system determines the location of the slider icon. Based upon the determined position of the slider icon, the system shifts the historical data, discards portions of the historical data that have been shifted off the display grid, and begins appending new data points at the position of the slider. At one extreme position of the slider, all historical data is erased each time the screen fills up while, at the other extreme, only a single historical data point is deleted when a new data point is generated.

### BRIEF DESCRIPTION OF THE DRAWINGS

Other objects and advantages of the invention will become apparent upon reading the following detailed description and upon reference to the accompanying drawings in which:

FIG. 1 is a block diagram of selected features of a data processing system suitable for use with one embodiment of the present invention;

FIG. 2 is a conceptual representation of a system memory of the system of FIG. 1 according to one embodiment of the present invention;

FIG. 3 is a flow diagram of a method of controlling a real-time display according to one embodiment of the present invention; and

FIG. 4 and FIG. 5 are illustrative examples of a display screen according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

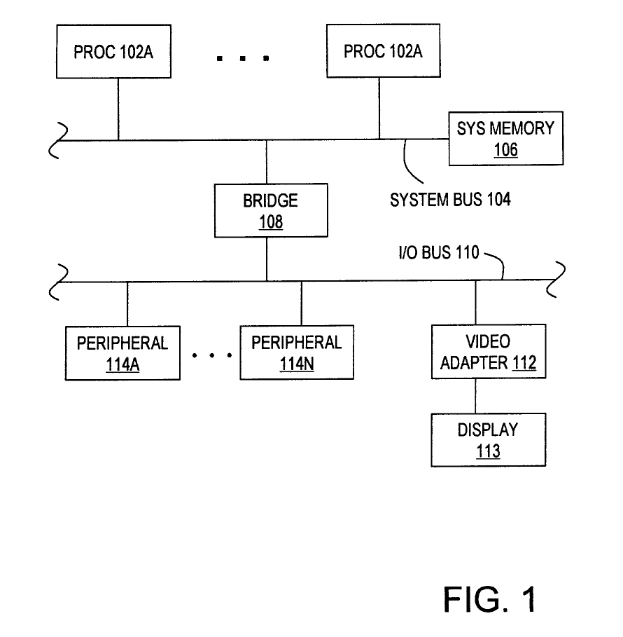

Turning now to FIG. 1 of the drawings, a block diagram of selected features of a multiprocessor data processing system 100 suitable for implementing the present invention is depicted. In the depicted embodiment, system 100 includes a set of two or more main processors 102A through 102N (generically or collectively referred to as processor(s) 102) that are connected to a system bus 104. Processors 102 may be implemented with commercially distributed general purpose microprocessors including, as examples, the PowerPC® family of processors from IBM Corporation and x86 type processors such as the Pentium® family of processors from Intel Corporation. A system memory 106 is accessible to each processor 102 via system bus 104. Because each processor 102 has substantially equal access to system memory 106 such that the memory access time is substantially independent of the processor, the depicted embodiment of system 100 is an example of a symmetric multi-processor (SMP) system. Although the depicted embodiment of system 100 is an SMP system, it will be appreciated that the invention may be employed by systems having alternative architectures and designs including, as examples, uni-processor systems and multi-processing systems having a non-uniform memory architecture (NUMA) design.

In system 100, a bus bridge 108 provides an interface between system bus 104 and an I/O bus 110 to which one or more peripheral devices 114A through 114N (generically or collectively referred to as peripheral device(s) 114). Peripheral devices 114 may include devices such as a high-speed network adapter, hard-disk controller, and the like. I/O bus 110 is typically compliant with one of several industry standard I/O bus specifications including, as an example, the Peripheral Components Interface (PCI) bus as specified in PCI Local Bus Specification Rev 2.2 by the PCI Special Interest Group (www.pcisig.com).

The depicted embodiment of system 100 includes a video adapter (also referred to as a graphics adapter) 112 connected to an I/O bus 110. Video adapter 112, as its name implies, provides dedicated hardware support to system 100 for graphics applications. Video adapter 112 connects a display device 113 to system 100 through I/O bus 110. Display device 113 typically comprises a display terminal or display screen of the system 100.

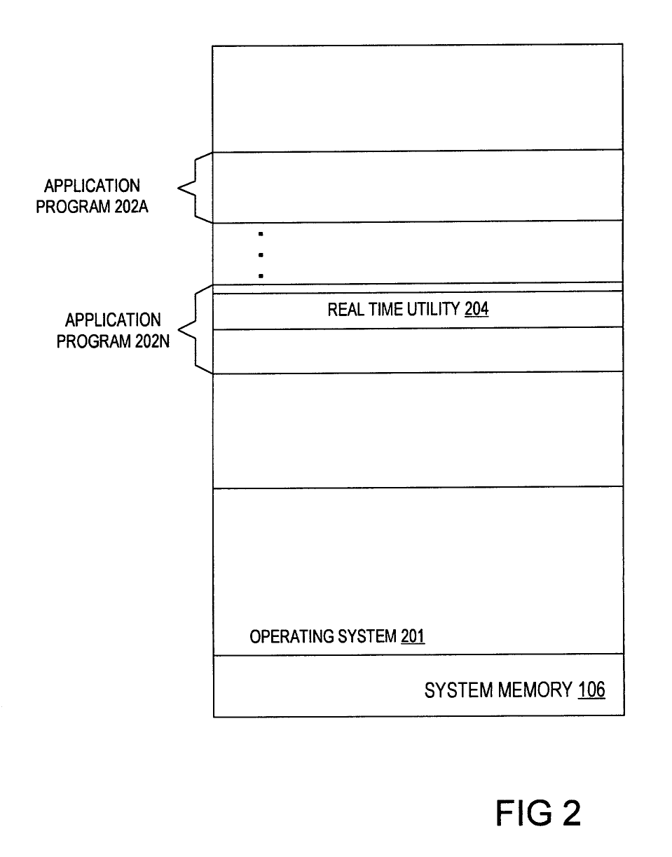

Portions of the present invention may be implemented as a set of computer executable instructions (software) stored on a computer readable medium such as system memory 106, a cache memory (not depicted) of a processor 102, or a floppy diskette, hard disk, CD ROM, DVD, magnetic tape, or other suitable storage element. Referring now to FIG. 2, a conceptual illustration of software stored in system memory 106 for use in conjunction with the present invention is presented. In the illustrated embodiment, system memory 106 includes at least portions of an operating system represented by reference numeral 201. Operating system 201 as used herein refers to those program modules within system 100 that govern the control of system resources including processors 102, system memory 106, disk storage (not explicitly depicted), peripheral devices 114, as well as information in the form of files or documents. General information regarding operating systems is available from a various sources including Madnick & Donovan, Operating Systems (McGraw-Hill 1974). Operating system 201 typically comprises a multi-tasking operating system that enables the execution of multiple application programs 202A through 202N (generically or collectively referred to as application program(s) 202). Operating system 201 may incorporate portions of commercially distributed operating systems such as a Unix® family operating system like the AIX® operating system from IBM Corporation, the Linux® operating system, or a Windows® family operating system from Microsoft.

Generally speaking, the present invention contemplates a system and method for displaying real-time data that enables the system user to control the manner in which the real-time data is displayed. More specifically, the invention contemplates the incorporation of a user-positionable icon into a graphical representation of real-time data. When the real time display is “full,” the position of the icon determines how much historical data is retained when a new data point is received.

As implemented in the embodiment depicted in FIG. 2, at least one of the application programs 202 includes a real-time display utility represented by reference numeral 204 that is configured to enable the user to modify the display of real-time displays such as the displays generated by system performance monitors. In other embodiments, real-time display utility 204 may be implemented as its own stand-alone application program. Application programs such as hardware management and deployment software frequently include performance monitor utilities. These performance monitor utilities frequently include means for displaying some real-time data in a graphical format. The real-time data may include, as examples, the instantaneous memory usage of system 100, the total number of 10, read, and write transactions per second, the amount of read and write data in MB per second, and so forth. In a conventional system, system utilities define the manner in which real-time data is displayed to the user thereby providing little, if any, user control over the display.

Real-time display utility 204 is configured to receive real-time data and display it in a graphical format suitable for viewing. The graphical format typically includes a two-dimensional graph in which the horizontal axis represents time and the vertical axis represents one or more parameters of interest. Typically, real time display utility 204 receives a new data point periodically at some predetermined frequency. In other embodiments, however, the data may be generated at varying time intervals based perhaps, upon some asynchronous signal.

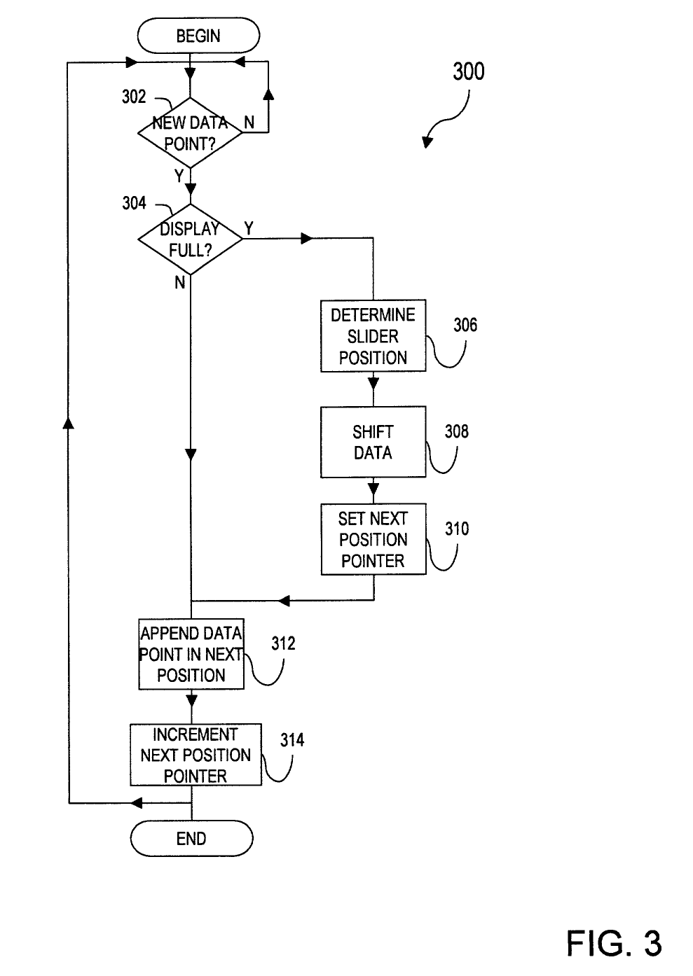

Referring now to FIG. 3, a flow diagram of a method 300 of controlling a real-time display of a data processing system according to one embodiment of the present invention is depicted. Real-time display control method 300 is initiated when a new data point is generated in block 302. Until such a point is generated, control method 300 is dormant. When a new data point is detected in block 302, real-time display method 300 determines (block 304) if the current display is full. For purposes of this disclosure, a display is full when the number of data points represented in the graph is equal to the number of x-axis positions of the graph. In a typical real-time display, new data points appear at the right hand edge of display and previous points extend to left of the new points such that the graph “grows” from right to left as new data points are plotted. When the older data points extend all the way to the left hand edge of the graph, the display is said to be full.

If the real time display is not full, the new data point is appended (block 312) to the display, typically in the data position immediately to the right of the preceding data point. If, however, the display is full, control method 300 according to the present invention determines (block 306) the position of a slider control icon. The display control method 300 according to the present invention updates the display by displacing or shifting (block 308) all data points horizontally to the left of the display screen where the amount of the horizontal displacement is determined by the position of the slider control icon.

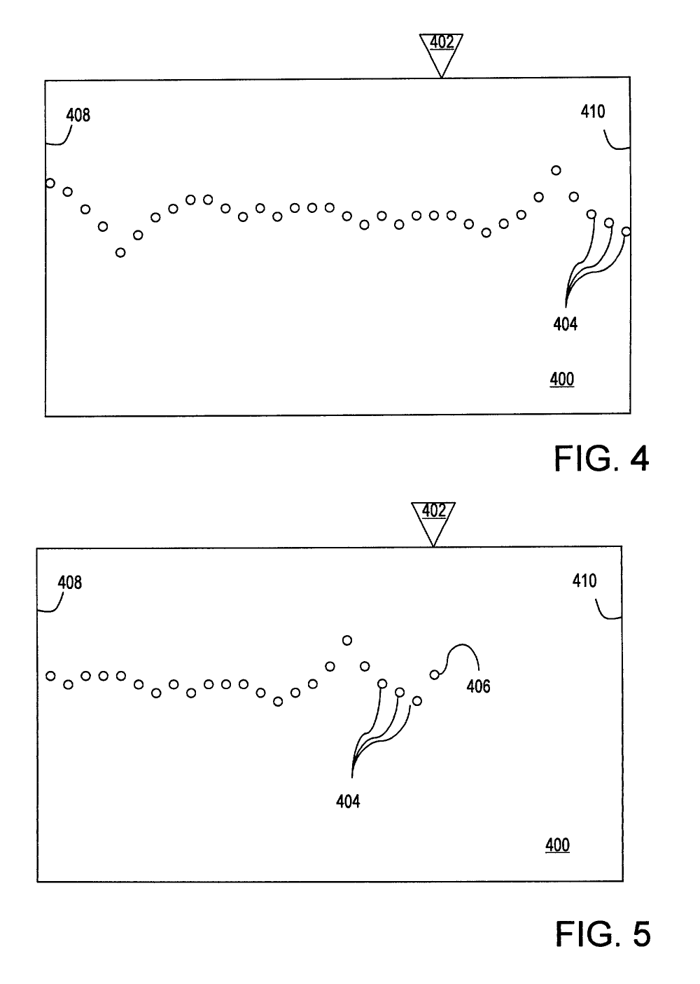

Referring temporarily to FIG. 4, an exemplary display screen 400 according to the present invention is depicted. Display screen 400 as depicted in FIG. 4 includes a slider control icon 402 positioned along the upper horizontal access of display screen 400. In addition, the display may include one or more data points 404 that represent data points taken from the corresponding data processing system. Alternatively, the data points could represent data points from another device, such as another data processing device connected to system 100 via a network connection. For purposes of this illustration, it is assumed that the points to the right are more recent data points than the points to the left with the right-most data point being the most recent. In the depicted illustration, the set of data points 404 has filled up the display screen 400. When the next data point is generated, the system will determine in block 304 that display screen 400 is full and then determine the horizontal position of slider control icon 402. Upon determining the horizontal position of slider control icon 402, the system is configured to refresh the screen by shifting all data points 404 to the left by an amount determined by the position of slider control icon 402. More specifically, the method 300 is configured to determine the distance between slider control icon 402 and the right side boundary 406 of display screen 400. Method 300 is then configured to shift each data point to the left by the determined distance.

Referring to FIG. 5, the display screen 400 of FIG. 4 is illustrated after a new data point is received. The data of FIG. 4 has been shifted to the left such that the new data point (reference numeral 406) is aligned with the horizontal position of icon 402. The data processing system according to one embodiment of the invention includes a graphical user interface (GUI) that enables a system user to move icon 402 to a desired position. As illustrated in FIG. 5, the position of icon 402 determines the amount of historical data that remains each time display screen 402 is updated. The position of icon 402 also determines the position of the first new data point that occurs after the screen is updated. Positioning icon 402 in alignment with left-side vertical axis 408 will erase all historical data each time display screen 400 is updated while positioning icon 402 in alignment with right-side vertical axis 410 will result in a shift of just one data point following each new update. By enabling the user to control the update position of the graphical display, the invention allows the user to control the amount of historical data that is retained when the display screen fills up and to control the appearance of the display.

Returning now to FIG. 3, following the shift of data in block 308, the system is configured to set a pointer indicating the horizontal position of the next data point. Immediately following a screen update, the next position pointer is aligned with the horizontal position of slider 402 such that the first data point following an update is aligned under the icon. After the next position pointer is set, the next data point can be appended (block 312) to the display. The pointer is then incremented (block 314) and the program returns to block 302 until the next data point is generated.

It will be apparent to those skilled in the art having the benefit of this disclosure that the present invention contemplates a system and method for controlling a real-time display screen in a data processing system. It is understood that the form of the invention shown and described in the detailed description and the drawings are to be taken merely as presently preferred examples. It is intended that the following claims be interpreted broadly to embrace all the variations of the preferred embodiments disclosed

What is claimed is:

1. A method of representing real time data in a graphical format on a display of a data processing system, comprising:
providing a user positionable icon as a portion of the display;
determining the position of the icon; and
refreshing the graphical representation responsive to receiving a new data point, wherein the position of the icon determines how much historical data is retained in the refreshed display.

2. The method of claim 1, wherein the graphical representation is refreshed when the graphical representation is full.

3. The method of claim 2, wherein the refreshing the representation comprises shifting all data points horizontally by a displacement, wherein the displacement is determined by the position of the icon.

4. The method of claim 1, further comprising appending a new data point to the display without discarding any historical data when the display is not full.

5. The method of claim 1, wherein the position of the icon determines the location of the first new data point occurring after the display is refreshed.

6. The method of claim 1, wherein representation includes a left side vertical axis and a right side vertical axis, wherein data points in proximity to the left-side vertical axis are older than data points in proximity to the right-side vertical axis.

7. The method of claim 6, wherein positioning of the icon at the left-side vertical axis will erase all historical data when the representation is refreshed and wherein positioning of the icon at the right side vertical axis will erase a single data point when the representation is refreshed.

8. A data processing system, including a processor, memory, and display, comprising:
computer code means for representing real time data in a graphical format on the display;
computer code means for displaying a user-positionable icon as part of the graphical representation and for determining the position of the icon; and
computer code means for refreshing the graphical representation responsive to receiving a new data point, wherein the position of the icon determines how much historical data is retained in the refreshed display.

9. The system of claim 8, wherein the graphical representation is refreshed when the graphical representation is full.

10. The system of claim 9, wherein the code means for refreshing the representation comprises code means for shifting all data points horizontally by a displacement, wherein the displacement is determined by the position of the icon.

11. The system of claim 8, further comprising computer code means for appending a new data point to the display without discarding any historical data when the display is not full.

12. The system of claim 8, wherein the position of the icon determines the location of the first new data point occurring after the display is refreshed.

13. The system of claim 8, wherein representation includes a left side vertical axis and a right side vertical axis, wherein data points in proximity to the left-side vertical axis are older than data points in proximity to the right-side vertical axis.

14. The system of claim 13, wherein positioning of the icon at the left-side vertical axis will erase all historical data when the representation is refreshed and wherein positioning of the icon at the right side vertical axis will erase a single data point when the representation is refreshed.

15. A computer program product for displaying real time data on a data processing system, the product being stored on a computer readable medium and comprising:
computer code means for representing real time data in a graphical format on the display;
computer code means for displaying a user-positionable icon as part of the graphical representation and for determining the position of the icon; and
computer code means for refreshing the graphical representation responsive to receiving a new data point, wherein the position of the icon determines how much historical data is retained in the refreshed display.

16. The computer program product of claim 15, wherein the graphical representation is refreshed when the graphical representation is full.

17. The computer program product of claim 16, wherein the code means for refreshing the representation comprises code means for shifting all data points horizontally by a displacement, wherein the displacement is determined by the position of the icon.

18. The computer program product of claim 15, further comprising computer code means for appending a new data point to the display without discarding any historical data when the display is not full.

19. The computer program product of claim 15, wherein the position of the icon determines the location of the first new data point occurring after the display is refreshed.

20. The computer program product of claim 15, wherein representation includes a left side vertical axis and a right side vertical axis, wherein data points in proximity to the left-side vertical axis are older than data points in proximity to the right-side vertical axis.

21. The computer program product of claim 20, wherein positioning of the icon at the left-side vertical axis will erase all historical data when the representation is refreshed and wherein positioning of the icon at the right side vertical axis will erase a single data point when the representation is refreshed.
